(19) United States
(12) Patent Application Publication
(10) Pub. No.: US 2026/0034760 A1
(43) Pub. Date: Feb. 5, 2026

(54) Counter Die Positioning Element for Making Graphic Marks on Flat Sheets, a Mold for Making Counter Dies Containing the Positioning Element, and the Method of Embedding the Positioning Element in the Counter Die

(71) Applicant: Stamp Systems sp. z o.o., Sady (PL)

(72) Inventor: Andrzej Wasiuta, Poznan (PL)

(21) Appl. No.: 19/224,337

(22) Filed: May 30, 2025

(30) Foreign Application Priority Data
Aug. 4, 2024 (EU) EP24192636.9
Oct. 3, 2024 (EU) EP24204458.4

(51) Int. Cl. B31F 1/07; B29C 33/30; B29C 33/38

(52) U.S. Cl. CPC B31F 1/07; B29C 33/303; B29C 33/3842; B31F 2201/0702

(57) ABSTRACT

A positioning element for a counter die for making graphic marks on flat sheets for packaging is shown. It includes at least a ring 0.2 to 0.8 mm thick, shaped on both sides, and made of ferromagnetic material. The ring has a hole that fits into a mold cavity of the counter die. A mold for making a counter die containing a positioning element for a counter die for making graphic marks on flat sheets for packaging is also described. The mold is provided with sockets for fixing the position of rings, wherein each socket is a cylinder facing with its apex, a surface of the mold together with a milled base to a minimum depth equal to a thickness of the rings, a number of sockets being equal to number of rings.

The instant application claims priority to European Application EP24192636.9 filed on Aug. 2, 2024, presently pending, and European Application EP24204458.4, filed on Oct. 3, 2024, presently pending, the contents of which are hereby incorporated by reference.

### BACKGROUND OF THE INVENTION

The object of the invention is a Counter die positioning element for making graphic marks on flat sheets, a mold for making counter dies containing the positioning element, and a method for embedding the positioning element in the Counter die.

### SUMMARY OF THE INVENTION

From the Polish patent description PL206750 B1 is known a device for the precise positioning of printed objects having screen printing, offset, hot stamping and/or lacquered printing units, which has a lift and subassemblies with pins for fixing the products to be printed, characterized in that it has a linear electric motor for moving the work carriage, while the body of the linear motor is seated along the skeleton of the device, the skeleton being divided into parts holding the modules, which are the printing units. Whereby the printing modules are the same and consist of a horizontal support plate, in which the sockets for fixing the dies are situated, and the assembly for fixing the filling and scraping squeegee, and on the upper surface of the support plate, the assembly for moving the dies is situated.

From the Polish patent application PL427004 A1 there is known a printing form of a printing cylinder of a printing machine used in the process of refining offset printing in the form of a plate having the form of a ring surrounding the surface of the printing cylinder, characterized by the fact that the plate is provided with working sockets, arranged on the surface of the plate, in which there are replaceable elements in the form of stamps flush with the surface of the plate, located in the working sockets from the inner side of the surface of the form. Advantageously, the punch consists of elements consisting of a square base positioned in the lower opening of the working cavity, a working element positioned in the upper opening of the cavity, and a working surface constituting the facing layer of the working element provided with a pattern, the surface of which protrudes above the outer surface of the plate, joined inseparably.

From US patent application US2010289184 A1 is known an apparatus for performing imprint lithography on a substrate having a formable surface, comprising in operation: a mold having a moldable surface for imprinting a moldable surface with a pattern having microscale or nanoscale features; a movable positioning element for holding and positioning a substrate or mold with a moldable surface adjacent to the moldable surface; and a press for pressing the mold and substrate against the substrate or mold on the positioner by opposing lateral forces that are balanced to minimize the resultant lateral force acting on the positioner.

In the state of the art, methods of making relief on various surfaces are known. For example, from the Polish patent application PL360083 A1, a method of positioning a Counter die on a pressure roller of an embossing station, cooperating with an embossing roller provided with a stamp, is known. On the punch of the embossing roller, a temporarily flexible portable Counter die, provided with a window for fitting, is fixed. The mobile Counter die is transferred from the embossing roller to the pinch roller and fixed to the pinch roller. The mobile Counter die is then clamped in a precisely defined position in the Counter die window.

From the Polish application description PL403502 A1 is known a method of manufacturing embossed cardboard packaging, in which the surface of the cardboard is printed with offset printing and the embossing of the cardboard is achieved by means of a die and a Counter die. The working surface of the die is formed by means of a cutter engraving in a plastic, preferably polycarbonate, and the working surface of the Counter die is formed by means of a cutter engraving in a plastic, preferably PVC, and during the embossing process a compression layer, preferably formed of hard rubber, is placed under the Counter die.

In the state-of-the-art process of embossing sheets of fibrous materials (cardboard), it is necessary for the Counter die to cooperate with the die plate. In order to produce the graphic mark on a cardboard sheet using the cold embossing technique, the precise positioning of the embossing element pair Counter die—die is required, without the introduction of pegging, tongue and groove, or any other shaping unit. A prerequisite for the correct execution of the graphic mark is that the element centering the mutual position of the embossing pair does not leave a trace on the sheet after the embossing process.

For this purpose, pins of various diameters and lengths are currently used, which are only inserted into the die and the Counter die when these components are assembled in the stamping machine. A minimum of 2 positioning pins is required per die/pattern set. The number of pins depends on the size of the Counter die.

Once the embossing machine is ‘closed’, the Counter die is transferred to a steel counter plate and adhered to it using double-sided tape. All pins used are then manually removed from the dies, as their falling out during the operation of the machine can cause damage to the graphic design on the Counter die plate or the die.

The installation and removal of dowels is carried out using standard or special—dedicated—grippers. This is dependent on the type of pin used.

In the process of embossing printed cardboard sheets, it is often necessary to correct the position of the die and the Counter die before the actual embossing process begins. The printing process and the conditions in which the paper is stored result in frequent changes in size relative to the design according to which the print and the matrices are made.

Correction of the position of the matrices and the counter dies requires re-positioning of the counter dies relative to the die, for which the positioning pins are used again. The pins have to be removed from the dies each time after mounting the die and transferring the master to the counter plate in the machine. This process can take between 15 and 80 minutes, depending on the number of matrices used.

The positioning methods used to date have disadvantages, not excluding their use, but necessitating the use of additional accessories in the form of positioning pins and grippers or other tools for their assembly/disassembly, which directly increases their handling time.

The purpose of the present invention is to overcome the disadvantages existing in solutions known to the state of the art and to provide a Counter die positioning element of simple design and a method of fixing it.

The essence of the invention is a Counter die positioning element for making graphic marks on flat sheets for packaging, characterized in that it is a ring with a thickness of 0.2 to 0.8 mm shaped on both sides, made of ferromagnetic material, which has a hole for fitting it into the socket of the Counter die mold.

Advantageously, the said sheets for making graphic signs are made of solid, non-porous materials or non-woven, cellulose materials.

Advantageously, the ferromagnetic material is selected from the group including iron, cobalt, nickel, their alloys, and carbon steel.

Advantageously, the ring has a thickness of 0.2 to 0.4 mm. Advantageously, the ring is flat on both sides.

Advantageously, the ring is provided with a crown with at least three arms oriented in the direction tangent to the circle of said ring.

Advantageously, the crown has four arms.

Advantageously, the arms of the crown in the first section are parallel to the surface of the ring and in the second section towards the outer edge of the ring are bent at an acute angle downwards to a depth of not less than half the thickness of the ring, the first section being a distance of between 0.2 mm and half the width of the ring calculated from its inner diameter.

Another object of the invention is a mold for making counter dies containing a positioning element according to the invention, characterized in that it is provided with socket for fixing the position of the rings, where each eat is a cylinder facing the apex of the molds with a milled base to a minimum depth equal to the thickness of the rings, with the number of sockets equal to the number of rings.

Advantageously, the mold, according to the invention is provided with a channel milled under each socket overlapping 30-70% of the width of the ring on its outer side.

Advantageously, the said channel has a diameter of five to ten mm and a depth of 0.08 to 0.3 mm. Advantageously, the mold according to the invention contains from two to eight sockets.

Another essence of the invention is a method for embedding a positioning element according to the invention in a Counter die using a mold according to the invention characterized in that the Counter die is made by an over molding process, and the method comprises the following steps: (a) placing at least two rings in the sockets of the mold before the start of the injection cycle when the mold of the injection molding machine is open, (b) starting the injection cycle, in which each mold channel located under the socket with the seated ring is filled with a plastic-liquid warp material, (c) adhesively bonding the rings to the made Counter die by solidifying the warp material; or the Counter die is made in a pressing process, and the method comprises the following steps: (a′) placing at least two rings in the slots, (b′) pouring the warp material onto the mold and covering it with a sheet of fiberglass sheet, (c′) placing the whole in a heated press and making the Counter die by bonding the warp material, at least two rings and the fiberglass sheet, (d′) leaving the made Counter die to harden.

Advantageously, the Counter die is made by an over molding process and in step (a) at least two rings have a crown and are placed in the mold sockets with the crowns on the outside of the mold containing the engraved Counter die design.

Advantageously, the Counter die is made in the pressing process and at least two flat rings on both sides are used in step a′).

The invention provides the following benefits:
The construction of the positioning element according to the invention and the method of embedding it in the Counter die using the mold according to the invention is very accurate and allows the positioning of a pair of stamping elements to be determined unambiguously;
Equipping the positioning element according to the invention with a crown aids its unchanging position in the injection mold before and during injection, avoiding deformation, displacement, and underflow of the plastic polymer as a result of a high-pressure jet of molten polymer;
The invention allows a significant reduction in the machine operator's supervision to determine the position of the pattens, which translates into a saving of up to 80% in machine setup time for stamping tools.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1 shows a positioning element according to the invention in one embodiment.

FIG. 2 shows a permanent magnet placed in a die per one embodiment.

FIG. 3 shows the positioning element according to the invention in a different embodiment.

FIG. 4 schematically shows the socket of the positioning element per one embodiment.

FIG. 5 depicts the socket for the positioning element according to one embodiment.

FIG. 6 depicts a positioning element according to the invention in an embodiment having a crown placed in a socket of a mold according to the invention.

FIG. 7 shows a positioning element according to the invention in an embodiment.

FIG. 8 shows a finished counter die containing the positioning element according to one embodiment.

FIG. 9 shows an example of the positioning elements according to one embodiment.

### DETAILED DESCRIPTION

Unless otherwise specified, all technical and scientific terms used in this document shall have the same meaning as commonly understood by a person of ordinary skill in the field of invention.

Whereby, within the meaning of the invention, the phrase “in an embodiment” is to be understood as in one or more embodiments. Furthermore, the features present in the various executions may be combined with each other insofar as they are not mutually exclusive. The descriptions of the execution of the invention in the present application are given by way of illustration and are not intended to limit the scope of the invention. The described implementations include various features, not all of which are required in all implementations of the invention. Some implementations use only some of the features or possible combinations of features. The described variants of the executions of the invention and the executions of the invention comprising different combinations of the features mentioned in the described executions will come to the mind of experts in the field. The scope of the invention is limited only by the claims.

As described herein, the invention is a Counter die positioning element. A Counter die is also known as a negative die.

In a first aspect, the invention relates to a Counter die positioning element for making graphic marks on flat sheets for packaging, which is a shaped ring on both sides with a thickness of 0.2 to 0.8 mm. The ring is made of ferromagnetic material and has a hole for fitting it into a dedicated mold socket.

The positioning element, according to the invention cooperates with a magnet embedded in a die during the process of making graphic marks on flat sheets for packaging.

In one embodiment, the magnet cooperating with the ring's self-centering ferromagnetic material is a cylindrical element. Whereby, the number of magnets and their positioning in the dedicated die corresponds to the number and positioning of the rings in the Counter die. In an advantageous design, the diameter of the magnet is between 3 and 8 mm and its thickness is between 2 and 6 mm.

In one embodiment, the thickness of the ring is 0.2 mm. In another version, the ring thickness is 0.3 mm. In another version, the ring thickness is 0.4 mm. In another version, the ring thickness is 0.5 mm. In another execution, the thickness of the ring is 0.6 mm. In another execution, the thickness of the ring is 0.7 mm. In another version, the ring thickness is 0.8 mm.

In one embodiment, the ferromagnetic material is carbon steel, but other iron alloys can also be used.

The positioning element, according to the invention, is designed for positioning a polymer Counter die for making graphic signs on flat sheets. In an advantageous execution, the sheets are made of solid materials. In another embodiment, the sheets are made of non-porous materials. In another embodiment, the sheets are made of non-woven materials, which are advantageously cellulosic materials.

In one embodiment, the ring is flat on both sides. The ring, which is flat on both sides, is placed in the mold plate for pressing with either side.

In another embodiment, the ring is fitted with a crown whose arms are oriented tangential to the ring circle.

The ring with the crown is placed in the mold plate with the engraved Counter die shape on the shaped side towards the flat closing counter-mold. The crown is intended to position the ring invariably in the mold before and during injection molding, avoiding deformation, displacement and underflow of the plastic polymer as a result of a high-pressure jet of molten polymer.

In one embodiment, the crown has three arms. In another execution, the crown has four arms. In a favorable execution, the width of each arm is 0.7 mm.

The arms of the crown in the first section are parallel to the surface of the ring and in the second section, towards the outer edge of the ring, are bent at an acute angle downwards to a depth of not less than half the thickness of the ring. Whereby, the first section is a distance of between 0.2 mm and half the width of the ring calculated from its inner diameter.

In one embodiment, the first section is a distance of 0.2 mm from the internal diameter of the ring. In another execution, the first section is a distance of 0.5 mm counted from the inner diameter of the ring. In another embodiment, the first section is a distance of half the width of the ring calculated from the inner diameter of the ring.

In one embodiment, the downward bending of the crown shoulders at the second section occurs to a depth of half the thickness of the ring. In another embodiment, the downward bending of the shoulders of the crown in the second section occurs to a depth of 0.3 mm. In another implementation, the downward bending of the shoulders of the crown in the second section occurs to a depth of ⅔ of the thickness of the ring. In another embodiment, the downward bending of the crown shoulders in the second section occurs to a depth of ¾ of the ring thickness. In one embodiment, the surface between the crown shoulders is flat and has a thickness of 0.2 mm. In another embodiment, the surface between the crown arms is flat and 0.3 mm. In another embodiment, the surface between the crown arms is flat and 0.4 mm thick.

In a further aspect, the invention relates to a mold for making patties comprising a positioning element according to the invention, which is provided with slots for fixing the position of the rings, wherein each slot is a cylinder facing with its apex the surface of the mold together with a milled base to a minimum depth equal to the thickness of the rings, the number of slots being equal to the number of rings.

In one embodiment, the diameter of the cylindrical socket is equal to the inner diameter of the ring or smaller by a maximum of 0.05 mm. In one embodiment, the socket can be between 1 and 4 mm wide.

In one embodiment, the mold according to the invention has a socket cylinder fixing the position of the ferromagnetic ring facing the apex of the mold surface, together with a milled base to a depth of 0.23 mm. The diameter of the cylinder is equal to the inner diameter of the ring in tolerance −0.04/+0 mm.

An additional element of the mold construction, according to the invention, is a channel milled under the ring socket. This channel is filled with a plastic-liquid warp material during the pressing or over molding process, and after it has hardened/solidified, it adhesively connects the ring to the part to be made.

In one embodiment, the channel milled under the ring socket can be between five and ten nm in diameter.

In one embodiment, the mold according to the invention is provided with a channel milled under each socket overlapping 30-70% of the width of the ring on its outer side.

In one embodiment, the channel is between five and ten mm in diameter. In one embodiment, the channel depth ranges from 0.08 to 0.3 mm.

In one embodiment, a channel with an external diameter of 9.5 mm and a width of 1.5 mm is milled around the socket cylinder under the ring socket. The depth of the channel is 0.1 mm.

In one embodiment, the mold according to the invention is provided with two sockets. In another embodiment, the mold according to the invention is provided with three sockets. In another embodiment, the mold according to the invention is provided with four sockets. In another execution, the mold, according to the invention, is provided with five sockets. In another embodiment, the mold according to the invention is provided with six sockets. In another embodiment, the mold according to the invention is provided with seven sockets. In another embodiment, the mold according to the invention is provided with eight sockets.

In a further aspect, the invention relates to a method for depositing a positioning element according to the invention using a mold according to the invention. In the case of making counter dies in the over molding process, before the start of the injection cycle, when the mold of the injection molding machine is open, the ferromagnetic ring according to the invention is manually placed in the mold cavity with the crown facing outwards of the mold containing the engraved pattern of the counter dies. The injection cycle is then started. In this cycle, the channel under the cavity in which the ring is seated is filled with a plastic-liquid warp material, after it has solidified/cured adhesively bonding the ring to the fabricated Counter die.

In the case of making counter dies in the pressing process, the counter dies are manually placed on a mold with an engraved counter dies pattern and a socket for a positioning ferromagnetic element according to the invention by resting them on the cylinder of the socket. The diameter of the cylinder in the socket causes a slight wedging of the ferromagnetic element for pressing. The warp material is then poured onto the mold, which is covered with a sheet of fiberglass plate. The whole is placed in a heated press and allowed to cure. This process fuses the warp material, the ferromagnetic element, and the fiberglass sheet to form the Counter die.

Whereby, in both variants of the method according to the invention, the positioning elements according to the invention are positioned as far as possible in the extreme parts of the mold. In this way, in the process of making graphic signs, the Counter die will be held by a magnetic force attached to the die equipped with magnets when the Counter die is transferred to the counter plate of the machine. As the size of the patches increases, positioning elements are additionally placed in the center and/or in accessible areas to increase the force maintaining its correct position in the die at the time of transfer of the patches to the counter plate. This principle also applies to the placement of the magnets in the die. Their position is exactly the same as that of the ferromagnetic elements in the Counter die.

In one embodiment, the method according to the invention comprises depositing a ring in an over molded Counter die and comprises the following steps: a) placing two rings in two mold sockets before the start of the injection cycle, when the mold of the injection molding machine is open; b) starting the injection cycle, in which each mold channel located under the socket with the deposited ring is filled with a plastic-liquid warp material; c) adhesively bonding the rings to the made Counter die by solidifying the warp material. Each of the rings is manually inserted into the mold socket with the crown facing outwards from the mold containing the engraved pattern of the Counter die; however, the diameter of the cylindrical socket causes a slight wedging of the ferromagnetic ring for the duration of the over molding cycle, preventing it from moving.

In another embodiment, the method according to the invention comprises embedding a ring in a Counter die made by the over molding process, and comprises (a) placing five rings in five mold sockets before the start of the injection cycle when the mold of the injection molding machine is open; (b) initiation of an injection cycle, in which each mold socket located under the cavity with the embedded ring is filled with a plastic-liquid warp material; c) adhesive bonding of the rings to the fabricated Counter die by solidification of the warp material. Each of the rings is manually inserted into the mold socket with the crown facing outwards from the mold containing the engraved pattern of the Counter die; however, the diameter of the cylindrical socket causes a slight wedging of the ferromagnetic ring for the duration of the over molding cycle, preventing it from moving.

In another embodiment, the method of seating the positioning element according to the invention involves the seating of the ring in a Counter die made in the pressing process and comprises the following steps: (a′) placing two rings, flat on both sides, in the sockets with either side, the diameter of the cylinder in the socket causing the ferromagnetic element to be slightly wedged for pressing; (b′) pouring the warp material onto the mold and covering it with a sheet of fiberglass sheet; (c′) placing the whole in a heated press and forming the Counter die by fusing the warp material, the rings and the fiberglass sheet; (d′) leaving the formed Counter die to harden.

In another embodiment, the method of seating the positioning element according to the invention involves the seating of the ring in a Counter die made by the pressing process and comprises the following steps: (a′) inserting four rings, flat on both sides, into the sockets with either side, the diameter of the cylinder in the socket causing the ferromagnetic element to be slightly wedged for pressing; (b′) pouring the warp material onto the mold and covering it with a sheet of fiberglass sheet; (c′) placing the whole in a heated press and forming the Counter die by bonding the warp material, the rings and the fiberglass sheet; (d′) leaving the formed Counter die to harden.

The embossing process is carried out by placing a sheet of cardboard between two plates of a press/machine in which a die is mounted, together with a Counter die. Closing the press with the appropriate force causes the graphic mark to be formed in accordance with the mold and Counter die made.

At least 2 magnets in the die and 2 positioning elements, according to the invention positioned in the Counter die are required. The positioning elements are placed as far as possible in the extreme parts of the Counter die, so that the magnetic force keeps the Counter die fixed to the die when the Counter die is transferred to the counter plate of the machine. As the size of the patches increases, positioning elements are additionally placed in the center and/or in accessible areas to increase the force maintaining its correct position in the die at the time of transfer of the patty to the counter plate. This principle also applies to the placement of the magnets in the die. Their position is exactly the same as that of the ferromagnetic elements in the Counter die.

In an advantageous embodiment, the arrangement of the positioning elements according to the invention in the Counter die and the magnets in the dedicated die comprises an arrangement: three magnets in the die and three ferromagnetic elements in the Counter die in an arrangement of two at the extremes and one in the middle.

In another advantageous embodiment, the arrangement of the positioning elements according to the invention in the Counter die and the magnets in the dedicated die comprises an arrangement of: four magnets in the die and four ferromagnetic elements in the Counter die in an arrangement of three extremes and one in the middle or four in the middle. The arrangement of the positioning elements according to the invention in the Counter die and the magnets in the dedicated die comprises an arrangement of: five 5 magnets in the die and five ferromagnetic elements in the Counter die in an arrangement of four extremes and one in the middle. The arrangement of the positioning elements according to the invention in the Counter die and the magnets in the dedicated die comprises an arrangement of: six to eight magnets in the die and six to eight ferromagnetic elements in the Counter die in an arrangement of four extremes and two to four in the inner part of the Counter die.

The attachment of the die depends on the type of machine that is used to perform the stamping. This can be double-sided tape, dedicated mounting brackets, mounting screws or other design elements defined by the machine manufacturer. The Counter die, on the other hand, is always glued to the counter plate or carrier using double-sided tape. Once its position has been established with the die, the machine closes, and the Counter die is transferred to the counter plate to which it is glued using double-sided tape.

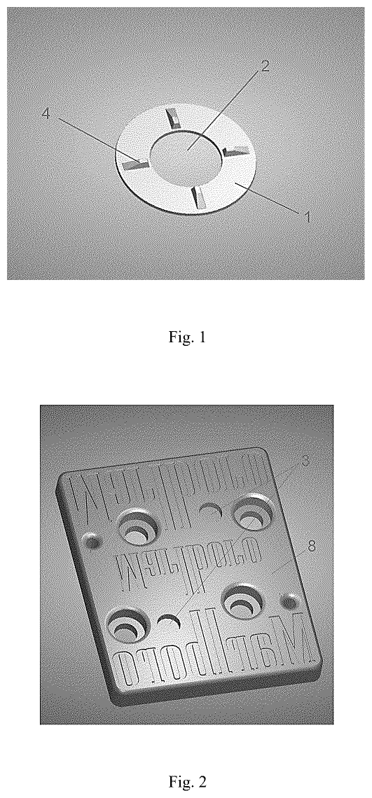

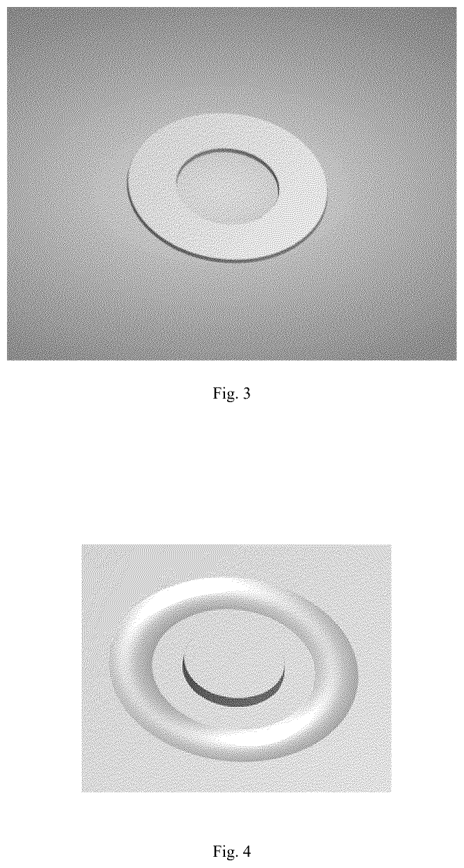

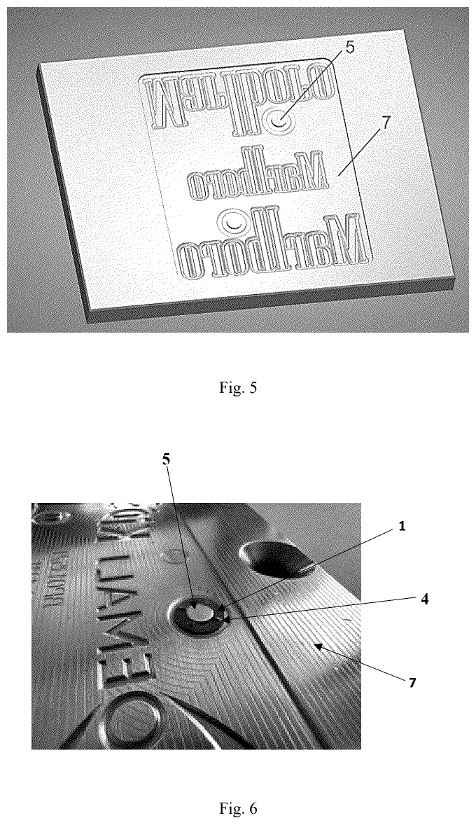

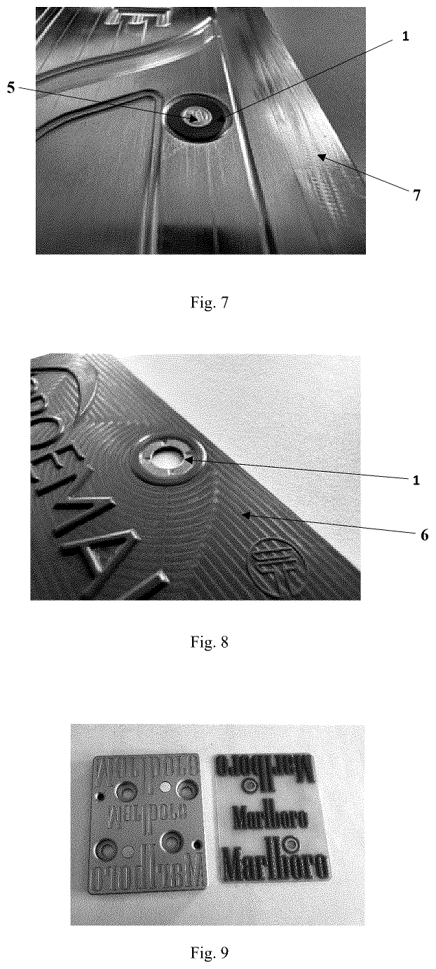

The invention is illustrated in worked examples and in the drawing, in which FIG. 1 shows a positioning element according to the invention in a variant with a crown; FIG. 2 shows a permanent magnet placed in a die; FIG. 3 shows the positioning element according to the invention in a variant in which the ring is flat on both sides; FIG. 4 schematically shows the socket of the positioning element; FIG. 5 depicts the socket for the positioning element according to the invention in the form according to the invention; FIG. 6 depicts a positioning element according to the invention in a variant with a crown placed in a socket of a mold according to the invention; FIG. 7 shows a positioning element according to the invention in a variant with both sides flat placed in a pressing mold; FIG. 8 shows a finished Counter die containing the positioning element according to the invention; FIG. 9 shows an example of the positioning elements according to the invention in the Counter die and the location of the magnets in a dedicated die.

### EXAMPLE 1

The positioning element, according to the invention, is designed for positioning a polymer Counter die 6 for making graphic marks on flat sheets made of solid, non-porous materials or non-woven materials (e.g., cellulose materials).

In this non-restrictive manufacturing example, the positioning element according to the invention is a 0.8 mm thick double-sided shaped ring 1 with a four-armed crown 4 (FIG. 1), which has a hole 2 for insertion into a socket 5 of a mold 7 (FIG. 2). The ring 1 cooperates with the magnet 3 embedded in the die 8 during the process of making graphic marks on flat sheets for packaging.

The diameter of the magnet ranges from 3 to 8 mm, and its thickness ranges from 2 to 6 mm. Whereby, the number of magnets 3 and their positioning in the dedicated die 8 corresponds to the number and positioning of rings 1 in the Counter die 6.

Ring 1 is made of a ferromagnetic material, which in this example is carbon steel. However, other ferromagnetic metals can also be used.

The purpose of the crown 4 is to position the ring 1 invariably in the mold 7 before and during injection molding, avoiding deformation, displacement, and underflow of the plastic polymer as a result of the high-pressure molten polymer jet. In this non-limiting manufacturing example, the crown 4 comprises four 0.7 mm wide arms, which are oriented in the direction tangent to the circle of the ring 1.

Whereby the arms of the crown 4 in the first section are parallel to the surface of the ring 1 and in the second section towards the outer edge of the ring 1 are bent at an acute angle downwards towards the outer edge of the ring to a depth of 0.3 mm, the first section being a distance of 0.5 mm calculated from the inner diameter of the ring 1. The surface between the arms is flat and 0.2 mm thick.

The ring with the crown 4 is placed in the mold plate 7 with the engraved Counter die 6, the shape side towards the flat closing counter form.

### EXAMPLE 2

Positioning element as in example 1, except that ring 1 is made of carbon steel and has a thickness of 0.2 mm. The crown 4, on the other hand, is provided with three arms which, at a section of 0.2 mm, are parallel to the surface of the ring 1 and, at a second section towards the outer edge of the ring 1, are bent at an acute angle downwards to a depth of half the thickness of the ring.

### EXAMPLE 3

Positioning element as in example 1 except that the arms of the crown 4 are parallel to the surface of the ring 1 in a first section, which is half the width of the ring 1 calculated from its inner diameter, and in a second section towards the outer edge of the ring 1 are bent at an acute angle downwards to a depth of half the thickness of the ring 1.

### EXAMPLE 4

Positioning element as in example 1, except that ring 1 is made of carbon steel, is 0.4 mm thick and is flat on both sides, as shown in FIG. 3.

### EXAMPLE 5

A mold 7 for making counter dies 6 containing a positioning element according to the invention—i.e. a ring 1—is provided with sockets 5 for fixing the position of the rings 1 in the form of a cylinder facing the surface of the mold 7 with a milled base to a depth equal to the thickness of the rings 1, the number of sockets being equal to the number of rings 1. In this example of execution, the mold 7 is provided with two sockets 5. A diagram of the sockets is shown in FIG. 4, while the mold 7 with sockets 5 is shown in FIG. 5.

In this example of manufacture, the mold 7 is provided with a channel milled under each socket 5 overlapping 30% of the width of the ring 1 on its outer side. Whereby, said channel has a diameter of 5 mm and a depth of 0.08 mm.

### EXAMPLE 6

Form as in example 5, except that the channel milled under each socket 5 overlaps 70% of the width of ring 1 on its outer side. Whereby, the channel has a diameter of 10 mm and its depth is 0.3 mm.

### EXAMPLE 7

The mold, as in example 5, except that it has a socket cylinder 5 fixing the position of the ferromagnetic ring 1 facing the apex of the mold surface 7 together with a milled base to a depth of 0.23 mm. The diameter of the cylinder is equal to the inner diameter of the ring 1 in tolerance −0.04/+0 mm.

On the other hand, a channel with an external diameter of 9.5 mm and a width of 1.5 mm is made around the cylinder of the socket 5, milled under the socket 5 of ring 1. This channel is filled with a plastic-liquid warp material during the pressing or over molding process, and after it solidifies/cures, it adhesively bonds ring 1 to the workpiece. The depth of the channel is 0.1 mm.

### EXAMPLE 8

Form as in example 5, except that it is fitted with five sockets 5.

### EXAMPLE 9

Form as in example 5, except that it is fitted with eight sockets 5.

### EXAMPLE 10

In this example implementation, the method of deposition of the positioning element according to the invention comprises the deposition of the ring 1 in the Counter die 6 made by the over molding process and comprises the following steps:
a) inserting the two rings 1 in the two sockets 5 of the mold 7 before the injection cycle starts when the mold 7 of the injection molding machine is open,
b) initiation of an injection cycle, in which each mold channel 7 located under the socket 5 with the embedded ring 1 is filled with a plastic-liquid warp material,
c) adhesive bonding of the rings 1 to the fabricated Counter die 6 by solidification of the warp material.

Whereby, as shown in FIG. 6, each of the rings 1 is placed in the socket 5 of the mold 7 manually, with the crown 4 facing outwards from the mold 7 containing the engraved Counter die design 6. However, the diameter of the cylindrical socket 5 causes a slight wedging of the ferromagnetic ring 1 for the duration of the over molding cycle preventing its movement. The finished Counter die is shown in FIG. 8, while an example of the distribution of the rings 1 in the example Counter die relative to the arrangement of the magnets 3 in the dedicated die 8 is shown in FIG. 9.

### EXAMPLE 11

Method as in example 10 except that step (a) comprises placing the five rings 1 in the five sockets 5 of the mold 7 before the start of the injection cycle when the mold 7 of the injection molding machine is open.

### EXAMPLE 12

In this example implementation, the method of seating the positioning element according to the invention comprises the seating of the ring 1 in the Counter die 6 made in the pressing process and comprises the following steps:
(a′) inserting the two, bilaterally flat rings shown in FIG. 3 into the sockets 5 with either side (as shown in FIG. 7), with the diameter of the cylinder in the socket causing a slight wedging of the ferromagnetic element for pressing;
(b′) pouring the warp material onto the mold 7 and covering it with a sheet of fiberglass board;
(c′) placing the whole in a heated press and producing the Counter die shown in FIG. 9 by bonding the warp material, at least two rings 1 and a fiberglass sheet;
(d′) leaving the fabricated Counter die shown in FIG. 9 to cure.

### EXAMPLE 13

The method as in example 12, except that step a′) comprises placing eight, bilaterally flat rings 1 in eight slots 5, either side, the diameter of the cylinder of the slot 5 causing the ferromagnetic element (ring 1) to be slightly wedged for pressing.

### LIST OF DESIGNATIONS

1—ring;
2—hole;
3—permanent magnet;
4—crown;
5—socket;
6—counter die
7—mold;
8—die.

In summary, the object of the invention is a Counter die positioning element for making graphic marks on flat sheets for packaging, characterized in that it constitutes a ring (1) with a thickness of 0.2 to 0.8 mm shaped on both sides, made of ferromagnetic material, which has a hole (2) for fitting it into the mold socket (7) Another object of the invention is a mold for making patches containing a positioning element according to the invention, characterized in that, that it is provided with sockets (5) for fixing the position of the rings (1), where each socket (5) is a cylinder facing the apex of the mold socket (7) together with a milled base to a minimum depth equal to the thickness of the rings (1), the number of sockets being equal to the number of rings (1). Another object of the invention is a method for embedding a positioning element according to the invention in a Counter die using a mold according to the invention, characterized in that the Counter die (6) is made by an over molding process comprising the following steps: (a) insertion of at least two rings (1) in the cavities (5) of the mold (7) before the start of the injection cycle when the mold (7) of the injection molding machine is open, (b) start of the injection cycle in which each channel of the mold (7) located under the cavity (5) with the embedded ring (1) is filled with a plastic-liquid warp material, (c) adhesive bonding of the rings (1) to the made Counter die (6) taking place by solidification of the warp material; or the Counter die (6) is made by pressing includes the following steps: (a′) placing at least two rings (1) in the sockets (5), (b′) pouring the warp material onto the mold (7) and covering it with a sheet of fiberglass plate. (c′) placing the whole in a heated press and making the Counter die (6) by bonding the warp material, at least two rings (1) and a fiberglass sheet. d′) leaving the fabricated Counter die shown in FIG. 9 to cure.

1. A positioning element for a counter die for making graphic marks on flat sheets for packaging, comprising:
a ring 0.2 to 0.8 mm thick, shaped on both sides, made of ferromagnetic material, which has a hole for fitting it into a mold cavity of the Counter die.

2. The positioning element according to claim 1, wherein said marking sheets are made of a solid, non-porous materials or non-woven, cellulose materials.

3. The positioning element according to claim 1, wherein the ferromagnetic material is selected from a group of ferromagnets comprising iron and its alloys.

4. The positioning element according to claim 1, wherein the ring has a thickness of 0.2 to 0.4 mm.

5. The positioning element according to claim 1, wherein the ring is flat on both sides.

6. The positioning element according to claim 1 wherein the ring is provided with a crown having at least three arms oriented in direction tangent to a circle of the ring.

7. The positioning element according to claim 6, wherein the crown has four arms.

8. The positioning element according to claim 6, wherein arms of the crown in a first section are parallel to a surface of the ring and in a second section towards an outer edge of the ring are bent at an acute downward angle to a depth of not less than half the thickness of the ring, the first section being a distance of 0.2 mm to half width of the ring calculated from its inner diameter.

9. A mold for making a counter die containing a positioning element for a counter die for making graphic marks on flat sheets for packaging, wherein the mold is provided with sockets for fixing the position of rings, wherein each socket is a cylinder facing with its apex, a surface of the mold together with a milled base to a minimum depth equal to a thickness of the rings, a number of sockets being equal to number of rings.

10. The mold according to claim 9, wherein it is provided with a channel milled under each socket overlapping 30-70% of a width of the ring on its outer side.

11. The mold according to claim 10, wherein the channel has a diameter of 5 to 10 mm and a depth of 0.08 to 0.3 mm.

12. A method of embedding a positioning element in a counter die using a mold, comprising a counter die made by an over molding process comprising following steps:
(a) insertion of at least two rings in cavities of the mold before starting an injection cycle when the mold of an injection molding machine is open;
(b) start of the injection cycle, in which each channel of the mold located under the cavity with the embedded ring is filled with a plastic-liquid matrix material;
(c) adhesive bonding of the rings to the counter die is carried out by solidification of the matrix material; or the counter die is made by pressing includes the following steps:
(a′) placing at least two rings in slots;
(b′) pouring the matrix material onto the mold and covering it with a sheet of fiberglass sheet;
(c′) placing in a heated press and making the Counter die by bonding the matrix material, at least two rings and the fiberglass sheet; and
(d′) leaving the made Counter die to harden.

13. The method according to claim 12, wherein the counter die is made by an over molding process, and in step (a) at least two rings have a crown and are placed in sockets of the mold with the crowns outside the mold containing an engraved pattern of the Counter die.

14. The method according to claim 12, wherein the counter die is made in the pressing process and at least two flat rings on both sides are used in step a′).

15. The positioning element according to claim 6, wherein the crown arms have a width of 0.7 mm.

16. The positioning element according to claim 8, wherein the acute downward angle of the crown arms is between 30° and 60°.

17. The mold according to claim 9, wherein the number of sockets in the mold ranges from two to eight.

18. The mold according to claim 10, wherein the channel is milled with a tolerance of ±0.02 mm to ensure precise alignment of the positioning element.

19. The method according to claim 12, wherein the matrix material used in step (b) is selected from thermoplastics, thermosetting resins, or composite materials to enhance adhesion between the positioning element and the Counter die.

20. The method according to claim 14, wherein the flat rings on both sides used in step (a′) are made of carbon steel for improved durability and magnetic response.
